(19) United States
(12) Patent Application Publication
(10) Pub. No.: US 2019/0130599 A1
(43) Pub. Date: May 2, 2019

(54) SYSTEMS AND METHODS FOR DETERMINING WHEN TO PROVIDE EYE CONTACT FROM AN AVATAR TO A USER VIEWING A VIRTUAL ENVIRONMENT

(71) Applicant: Tsunami VR, Inc., Del Mar, CA (US)

(72) Inventors: Morgan Nicholas GEBBIE, Carlsbad, CA (US); Bertrand HADDAD, Carlsbad, CA (US)

(21) Appl. No.: 16/175,384

(22) Filed: Oct. 30, 2018

Related U.S. Application Data
(60) Provisional application No. 62/580,101, filed on Nov. 1, 2017.

(51) Int. Cl. G06T 7/73; G06F 3/01; G06T 19/00; G06K 9/00

(52) U.S. Cl. CPC G06T 7/73; G06F 3/013; G06K 9/00342; G06K 9/00369; G06T 19/006

(57) ABSTRACT

Systems, methods, and non-transitory computer-readable media for determining avatar eye contact in a virtual reality environment are provided. The method can include determining a first pose of a first avatar for a first user in a virtual environment. The method can include determining a first viewing area of the first user and a first viewing region within the first viewing area based on the first pose. The method can include determining a second pose of a second avatar for a second user. The method can include determining a second viewing area of the second user and a second viewing region within the second viewing area based on the second pose. The method can include displaying the second avatar on a first device of the first user and displaying the first avatar on a second device of the second user based on the first viewing region and the second viewing region.

### CROSS REFERENCE TO RELATED APPLICATIONS

This application claims priority to U.S. Provisional Patent Application Ser. No. 62/580,101, filed Nov. 1, 2017, entitled “SYSTEMS AND METHODS FOR DETERMINING WHEN TO PROVIDE EYE CONTACT FROM AN AVATAR TO A USER VIEWING A VIRTUAL ENVIRONMENT,” the contents of which are hereby incorporated by reference in their entirety.

### BACKGROUND

### Technical Field

This disclosure relates to different approaches for enabling display of virtual information during mixed reality experiences (e.g., virtual reality (VR), augmented reality (AR), and hybrid reality experiences).

### Related Art

AR is a field of computer applications that enables the combination of real world images and computer generated data or VR simulations. Many AR applications are concerned with the use of live video imagery that is digitally processed and augmented by the addition of computer generated or VR graphics. For instance, an AR user may wear goggles or other a head mounted display through which the user may see the real, physical world as well as computer-generated or VR images projected on top of physical world.

### SUMMARY

An aspect of the disclosure provides a method for determining avatar eye contact in a virtual reality environment. The method can include determining, by at least one processor, a first pose of a first avatar for a first user in a virtual environment. The method can include determining a first viewing area of the first user in the virtual environment based on the first pose. The method can include determining a first viewing region within the first viewing area. The method can include determining a second pose of a second avatar for a second user in the virtual environment. The method can include determining a second viewing area of the second user in the virtual environment based on the second pose. The method can include determining a second viewing region within the second viewing area. The method can include displaying the second avatar on a first device of the first user and displaying the first avatar on a second device of the second user based on the first viewing region and the second viewing region.

Another aspect of the disclosure provides a non-transitory computer-readable medium comprising instructions for displaying an augmented reality environment. The non-transitory computer-readable medium can cause the one or more processors to determine a first pose of a first avatar for a first user in a virtual environment. The non-transitory computer-readable medium can cause the one or more processors to determine a first viewing area of the first user in the virtual environment based on the first pose. The non-transitory computer-readable medium can cause the one or more processors to determine a first viewing region within the first viewing area. The non-transitory computer-readable medium can cause the one or more processors to determining a second pose of a second avatar for a second user in the virtual environment. The non-transitory computer-readable medium can cause the one or more processors to determine a second viewing area of the second user in the virtual environment based on the second pose. The non-transitory computer-readable medium can cause the one or more processors to determine a second viewing region within the second viewing area. The non-transitory computer-readable medium can cause the one or more processors to display the second avatar on a first device of the first user and displaying the first avatar on a second device of the second user based on the first viewing region and the second viewing region.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a positioning system for enabling display of virtual information during mixed reality experiences;

FIG. 1B a functional block diagram of an embodiment of a positioning system for enabling display of virtual information during mixed reality experiences;

FIG. 2 is a graphical representation of a virtual environment with different objects and users at different poses for use in determining when to provide eye contact from an avatar to a user viewing a virtual environment;

FIG. 3A is a graphical representation of an embodiment of the virtual environment of FIG. 2;

FIG. 3B is a graphical representation of a viewing area of a first user of FIG. 3A;

FIG. 3C is a graphical representation of a viewing area of a second user of FIG. 3A;

FIG. 4A is a graphical representation of another embodiment of the virtual environment of FIG. 2;

FIG. 4B is a graphical representation of a viewing area of a first user of FIG. 4A;

FIG. 4C is a graphical representation of a viewing area of a second user of FIG. 4A;

FIG. 5A is a graphical representation of another embodiment of the virtual environment of FIG. 2;

FIG. 5B is a graphical representation of a viewing area of a first user of FIG. 5A;

FIG. 5C is a graphical representation of a viewing area of a second user of FIG. 5A;

FIG. 6A is a graphical representation of an embodiment in which more than one virtual thing is inside or intersected by a viewing region of a user;

FIG. 6B is a graphical representation of an embodiment of a process for determining where to direct eye contact of an avatar of a user when a viewing region of that user includes more than one virtual thing;

FIG. 6C is a graphical representation of a directional viewing region for use in determining when to provide eye contact from an avatar to a user viewing a virtual environment;

FIG. 6D is a graphical representation of a volumetric viewing region for use in determining when to provide eye contact from an avatar to a user viewing a virtual environment;

FIG. 6E and FIG. 6F are graphical representations of a method for resizing a viewing region for use in determining when to provide eye contact from an avatar to a user viewing a virtual environment;

FIG. 7 is a flowchart of a process for tracking and showing eye contact by an avatar to a user operating a user device;

FIG. 8 is a flowchart of a process for showing eye contact by an animated character to a user operating a user device; and

FIG. 9 is a flowchart of a process for tracking and showing eye contact by an avatar of a user towards a virtual object.

### DETAILED DESCRIPTION

This disclosure relates to different approaches for determining when to provide eye contact from an avatar to a user viewing a virtual environment.

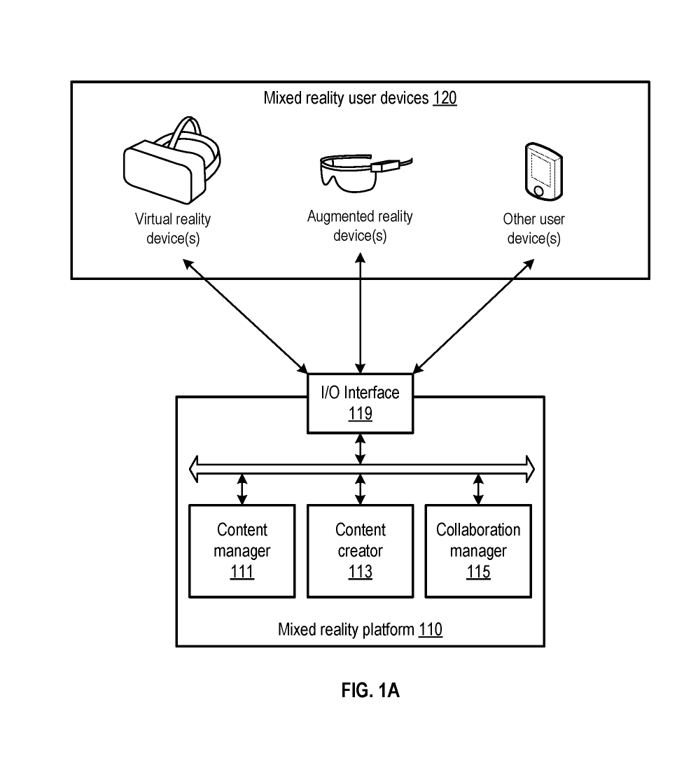

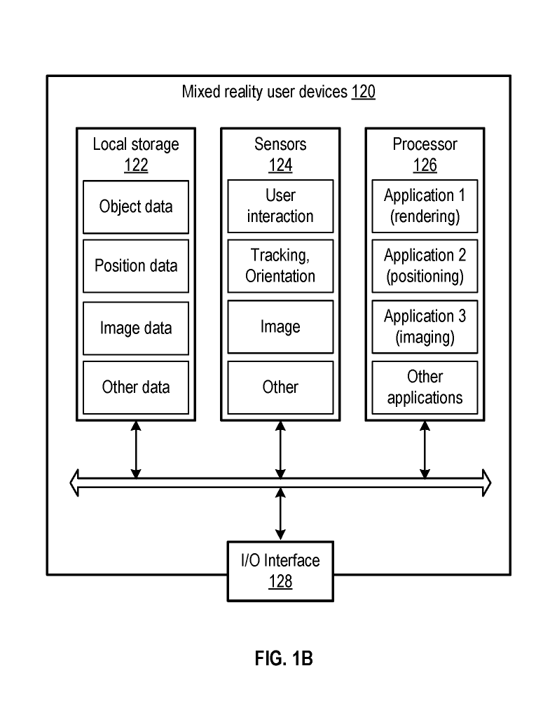

FIG. 1A and FIG. 1B are functional block diagrams of embodiments of a positioning system for enabling display of virtual information during mixed reality experiences. FIG. 1A and FIG. 1B depict aspects of a system on which different embodiments are implemented for determining when to provide eye contact from an avatar to a user viewing a virtual environment. As used herein, references to a user in connection with the virtual environment can mean the avatar of the user. A system for creating computer-generated virtual environments and providing the virtual environments as an immersive experience for VR and AR users is shown in FIG. 1A. The system includes a mixed reality platform 110 that is communicatively coupled to any number of mixed reality user devices 120 such that data can be transferred between them as required for implementing the functionality described in this disclosure. The platform 110 can be implemented with or on a server. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 111. The platform 110 and each of the content creator 113, the collaboration manager 115, and the I/O interface 119 can be implemented as one or more processors operable to perform the functions described herein. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users or avatars of the users in a virtual environment, interactions of users with virtual objects, and other information. The I/O interface 119 provides secure transmissions between the platform 110 and each of the user devices 120. Such communications or transmissions can be enabled by a network (e.g., the Internet) or other communication link coupling the platform 110 and the user device(s) 120.

Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions, such as those described herein. The processor(s) 126 can be adapted or operable to perform processes or methods described herein, either independently of in connection with the mixed reality platform 110. The I/O interface 128 from each user device 120 manages transmissions between that user device 120 and the platform 110. The sensors 124 may include inertial sensors that sense or track movement and orientation (e.g., gyros, accelerometers and others) of the user device 120, optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user or avatar of the user in virtual environments and physical environments. Tracking of user/avatar position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

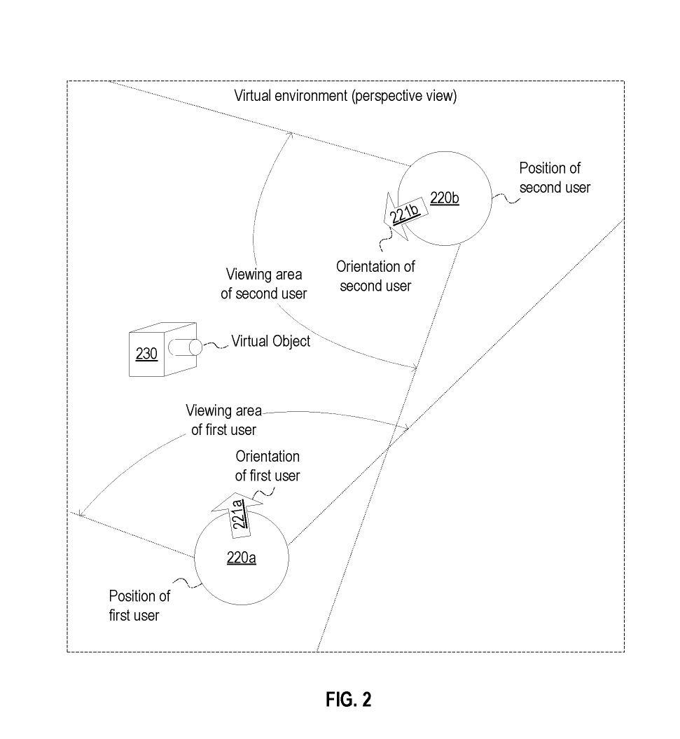

FIG. 2 is a graphical representation of a virtual environment with different objects and users at different poses for use in determining when to provide eye contact from an avatar to a user viewing a virtual environment. It is noted that the user of a VR/AR/XR system is not technically “inside” the virtual environment. However the phrase “perspective of the user” or “position of the user” is intended to convey the view or position that the user would have (e.g., via the orientation of user device) were the user inside the virtual environment. This can also be the “perspective of” or “position of the avatar of the user” within the virtual environment. It is the position of, or view a user would see viewing the virtual environment via the user device.

The virtual environment can have multiple exemplary objects and users at positions and with different orientations. As shown, a pose of a first user (e.g., a position 220a of the first user, and an orientation 221a of the first user), a pose of a second user (e.g., a position 220b of the second user, and an orientation 221b of the second user), and a pose (e.g., a position and an orientation) of a virtual object 230 are tracked in the virtual environment. A viewing area of each user is shown. The viewing area of each user defines parts of the virtual environment that are displayed to that user using a user device operated by that user. Example user devices include any of the mixed reality user devices 120. Other parts of the virtual environment that are not in the viewing area of a user are not displayed to the user until the user's pose changes to create a new viewing area that includes the other parts. A viewing area can be determined using different techniques or methods known in the art. One technique involves: (i) determining the position and the orientation of a user in a virtual environment (e.g., the orientation of the user's head or eyes); (ii) determining outer limits of peripheral vision for the user (e.g., d degrees of vision in different directions from a vector extending outward along the user's orientation, where d is a number like 45 or another number depending on the display of the user device or other reason); and (iii) defining the volume enclosed by the peripheral vision as the viewing area.

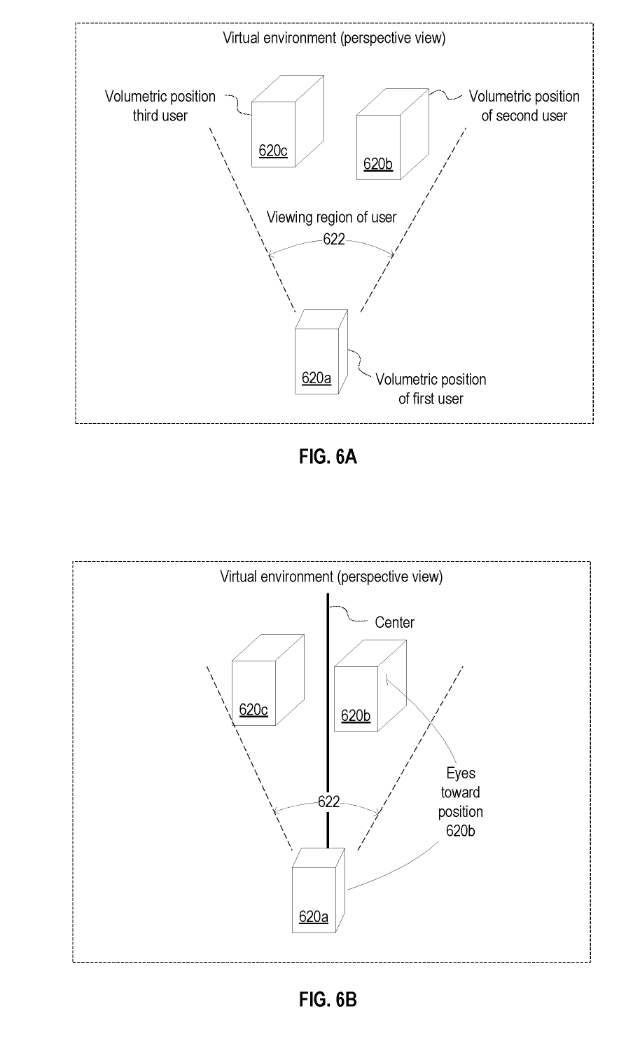

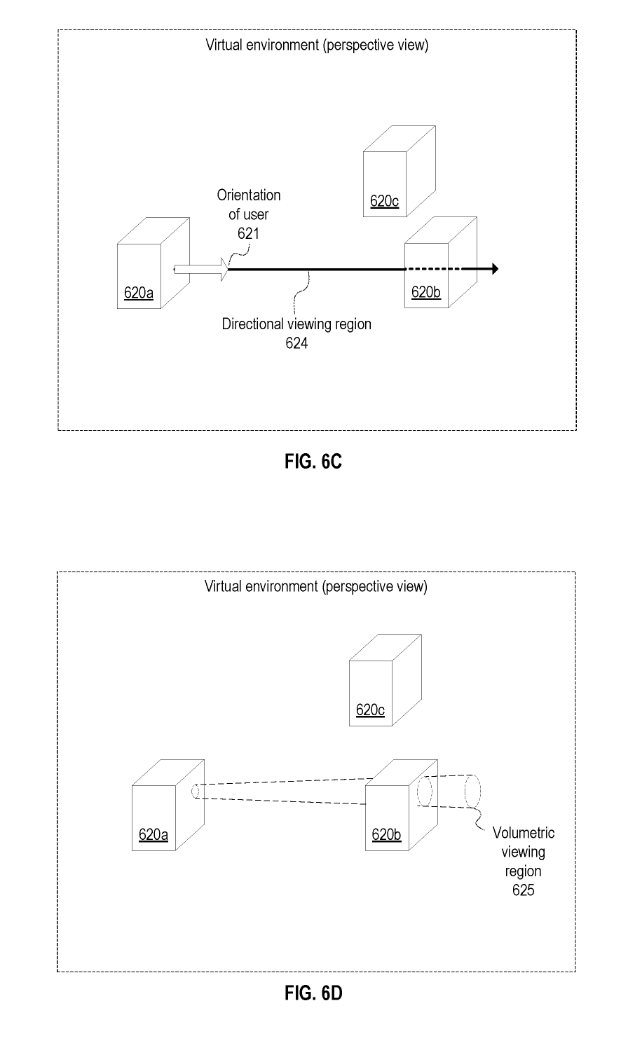

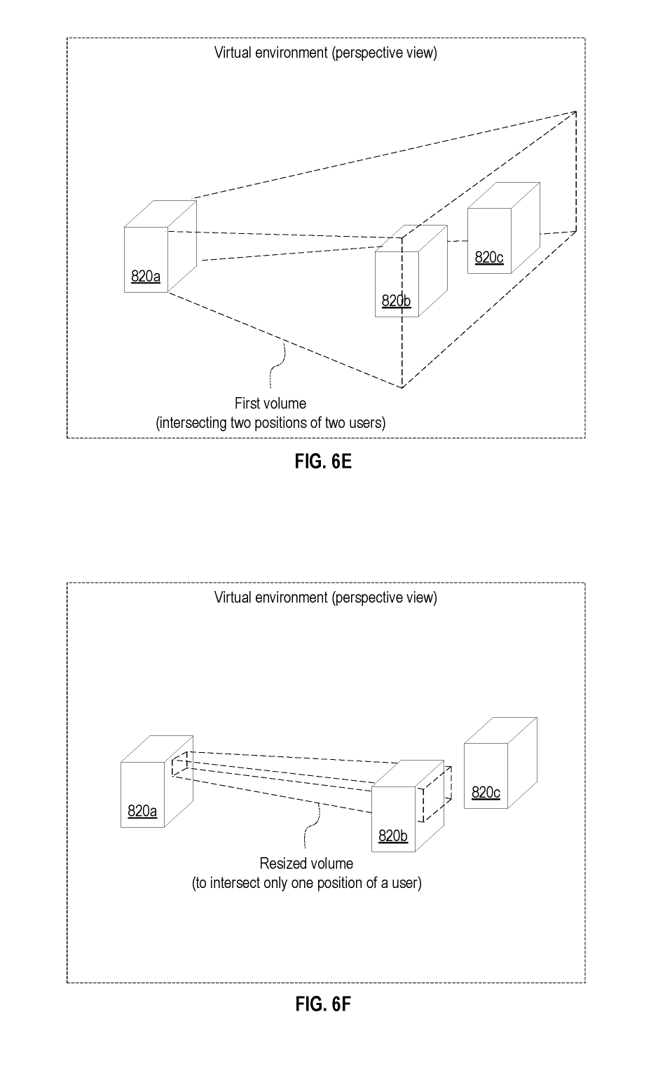

After a viewing area is defined, a viewing region for a user can be defined. The viewing area is show in dotted lines for both the first position 220a and the second position 220b. As described herein, a viewing region of a user can be used to determine where to direct eyes of an avatar representing that user when that avatar is in the viewing area of another user. A viewing region of the user is smaller than the viewing area of the user as shown and described in connection with the following figures. Different shapes and sizes of viewing regions are possible. A possible shape is a volume or a vector. An example of a volumetric viewing region is discussed later with reference to FIG. 6D. An example of a vector (“directional”) viewing region is discussed later with reference to FIG. 6C. Implications of different sizes of viewing regions are discussed later with reference to FIG. 6A and related figures. In some embodiments, the viewing region extends from the position of a user along the direction of the orientation of the user (e.g., the orientation of the user's head or eyes). The cross-sectional area of a volumetric viewing region may expand or contract as the volume extends outward from the user's position (e.g., a conical volume), or the cross-sectional area may remain unchanged as the volume extends outward from the user's position (e.g., a cylindrical volume, or a rectangular prism volume).

A viewing region can be determined using different techniques known in the art. One technique involves: (i) determining the position and the current orientation of a user in a virtual environment (e.g., the orientation of the user's head or eyes); (ii) determining outer limits of the viewing region (e.g., a vector, a width and height, or d degrees of vision in different directions from a vector extending outward along the user's current orientation); and (iii) defining the volume enclosed by the outer limits as the viewing region. The value of d can vary. For example, since users may prefer to reorient their head from the current orientation to see an object that is located more than 10 to 15 degrees from the current orientation, the value of d may be set to 10 to 15 degrees.

By way of example, the eyes of a first avatar representing a first user may be directed towards the eyes of a second user when the viewing region of the first user intersects or includes a position of the second user, a volume around that position, a volume around a position of a second avatar representing the second user, or a volume around a head or eyes of the second avatar. The same rationale applies for directing the eyes of the first avatar toward virtual objects instead of the second user.

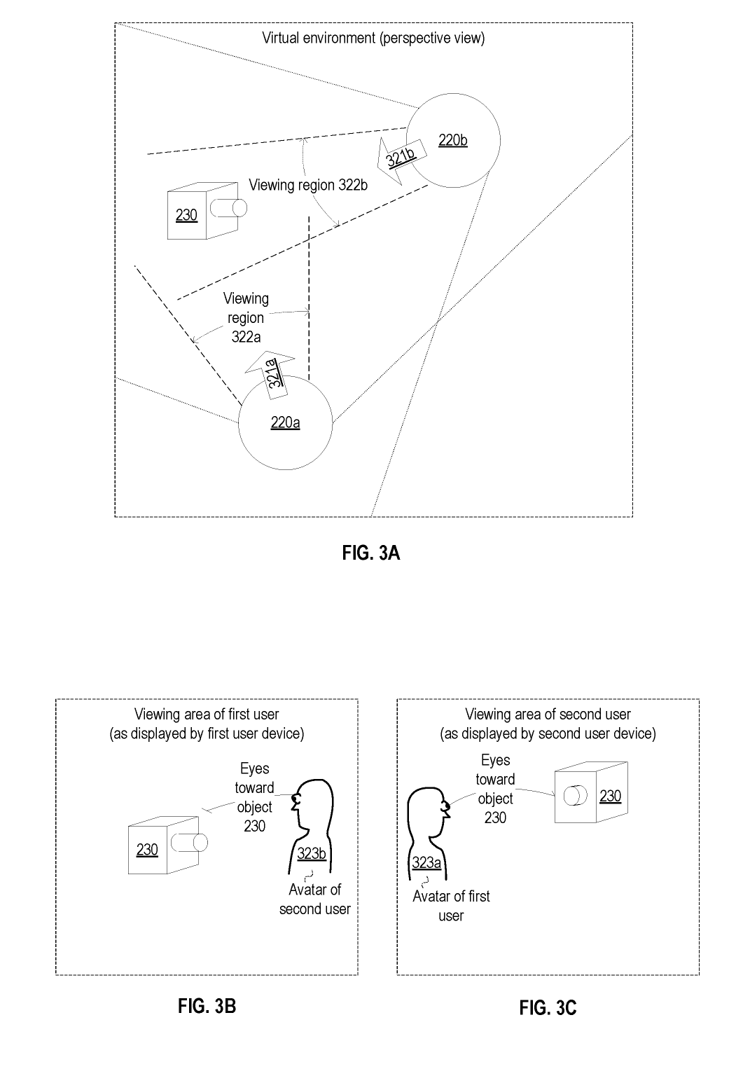

FIG. 3A is a graphical representation of an embodiment of the virtual environment of FIG. 2. The illustration of FIG. 3A depicts the viewing area of the first user in plan view. As shown in FIG. 3A, the virtual object 230 is positioned in a viewing region 322a (dashed lines) of the first user (e.g., avatar of the first user) at the position 220a and within a viewing region 322b (dashed lines) of the second user (e.g., avatar of the second user) at the position 220b. The viewing region 322a and the viewing region 322b are represented by angular areas between the dashed lines. The dotted lines in FIG. 3A represent the viewing areas of each user (FIG. 2).

FIG. 3B is a graphical representation of a viewing area of a first user of FIG. 3A. The illustration of FIG. 3B is shown in elevation view, depicting the viewing area of an avatar 323a of the first user under a first set of circumstances of FIG. 2. The viewing area of the first user is intended to correspond to the area between the dotted lines of the first position 220a of FIG. 3A. The eyes of an avatar 323b of the second user are directed towards the virtual object 230 as displayed to the first user.

FIG. 3C is a graphical representation of a viewing area of a second user of FIG. 3A As shown in FIG. 3C, the eyes of the avatar 323a of the first user are directed towards the virtual object 230 as displayed to the second user. The viewing area of the second user is intended to correspond to the area between the dotted lines of the second position 220b of FIG. 3A

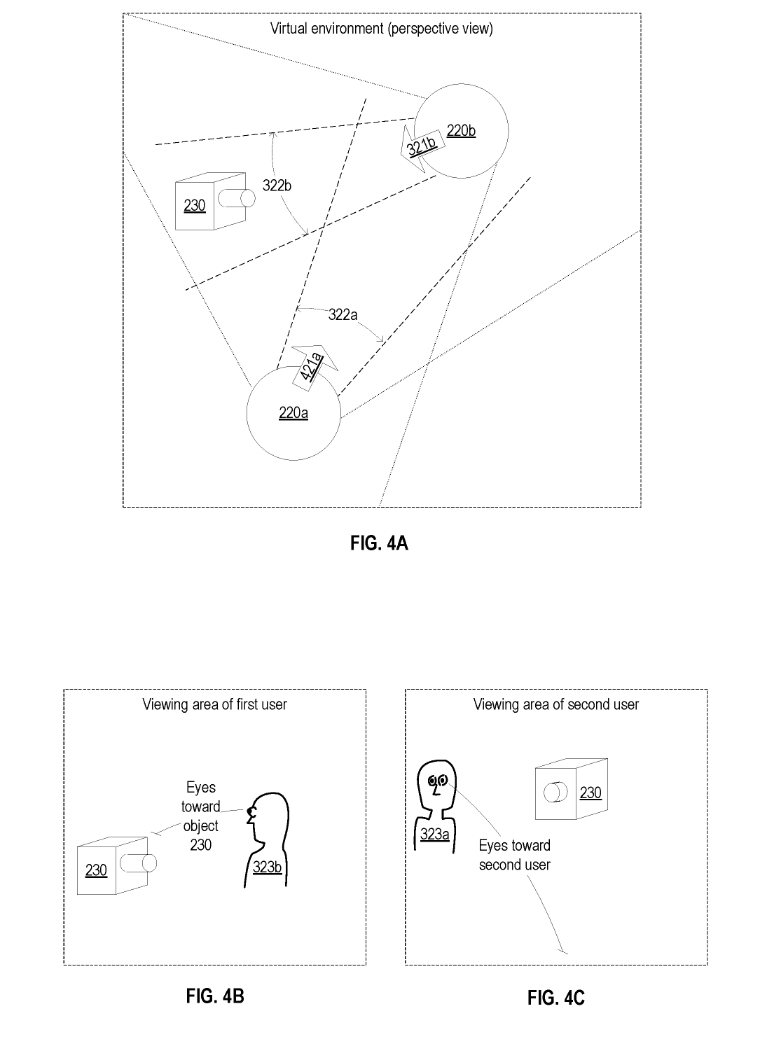

FIG. 4A is a graphical representation of another embodiment of the virtual environment of FIG. 2. As shown in FIG. 4A, the first user (e.g., the first avatar) moves into a new orientation 421a at the position 220a, which moves the viewing region 322a of the first user such that the position 220b of the second user (e.g., the second user's avatar 323b) fall within the viewing region 322a. The viewing region 322a and the viewing region 322b are represented by angular areas between the dashed lines. The dotted lines in FIG. 4A represent the corresponding viewing areas of each user (FIG. 2).

FIG. 4B is a graphical representation of a viewing area of a first user of FIG. 4A FIG. 4B depicts an elevation view of the first user (e.g., the first avatar 323a), viewing the second avatar 323b within the angular area between the dotted lines of the first position 220a. As shown in FIG. 4B, the eyes of the avatar 323b of the second user are still directed towards the virtual object 230 since the orientation 321b of the second user has not changed.

FIG. 4C is a graphical representation of a viewing area of a second user of FIG. 4A As shown in FIG. 4C, the eyes of the avatar 323a of the first user are directed towards the position 220b of the second user as displayed to the second user. FIG. 4C represents an elevation view of the second user (e.g., the second avatar 323b), viewing the first avatar 323a within the angular area between the dotted lines of the second position 220b. The second user can thus view the eyes of the first avatar 323a.

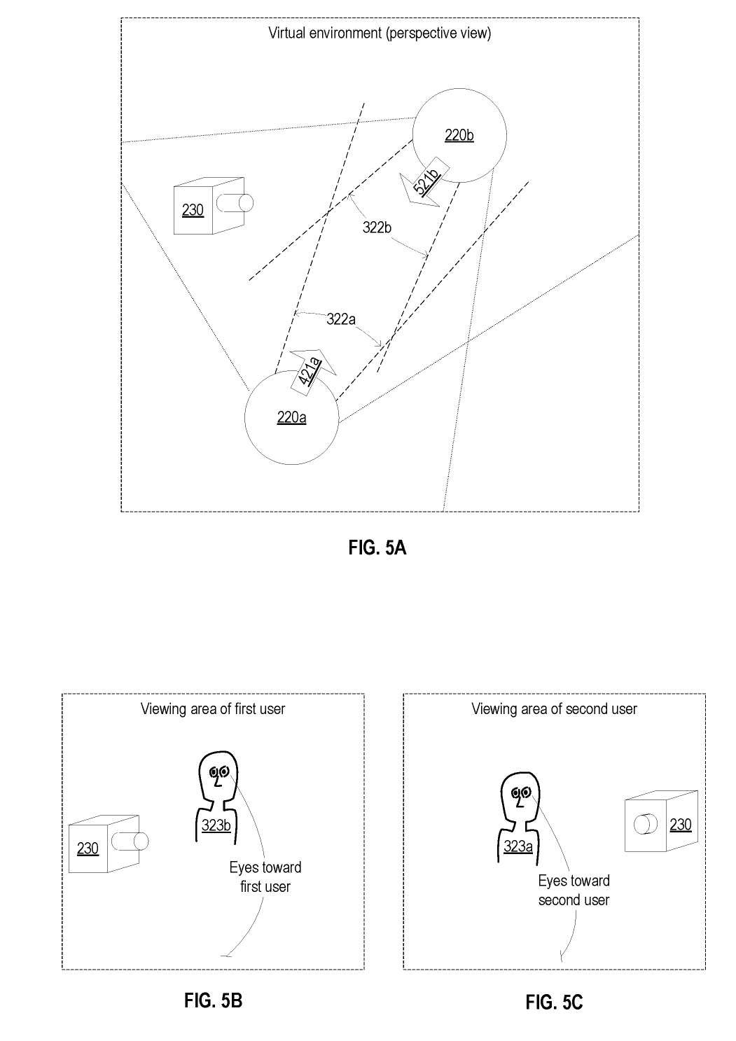

FIG. 5A is a graphical representation of another embodiment of the virtual environment of FIG. 2. As shown in FIG. 5A, the second user moves into a new orientation 521b, which moves the viewing region 322b of the second user such that the position 220a of the first user and the first user's avatar 323a are in the viewing region 322b.

FIG. 5B is a graphical representation of a viewing area of a first user of FIG. 5A. FIG. 5B depicts an elevation view of the viewing region 322a within the viewing area of the first user. The viewing area of the first user corresponds to the dotted lines from the first position 220a.

FIG. 5C is a graphical representation of a viewing area of a second user of FIG. 5A FIG. 5C depicts an elevation view of the viewing region 322b within the viewing area of the second user. As shown in FIG. 5B, the eyes of the avatar 323b of the second user are now directed towards the position 220a of the first user as displayed to the first user. As shown in FIG. 5C, the eyes of the avatar 323a of the first user are still directed towards the position 220b of the second user since the orientation 421a of the first user has not changed.

Viewing regions (e.g., the viewing regions 322a, 322b) can also be used to determine when to direct eyes or other feature of a non-user virtual object towards a position of a user. Other features may include any part of the virtual object (e.g., a virtual display screen or other). As with users, a position and an orientation of the virtual object can be used to determine a viewing region for the virtual object, and eye(s) or other feature of the virtual object would be directed towards a user's position when that user's position is in the viewing region of the virtual object.

In some cases, the viewing region includes or intersects with two or more virtual things (e.g., avatars, virtual objects). This scenario can be problematic since an avatar that represents a user can make eye contact with only one thing at a time. Thus, different types of viewing regions and analysis about viewing regions are contemplated.

FIG. 6A is a graphical representation of an embodiment in which more than one virtual thing is inside or intersected by a viewing region of a user. By way of example, FIG. 6A illustrates a scenario where more than one virtual thing lies within or is intersected by a viewing region of a user. As shown, a viewing region 622 of a first user extends from a volumetric position 620a of the first user, and includes a volumetric position 620b of a second user and a volumetric position 620c of a third user.

FIG. 6B is a graphical representation of an embodiment of a process for determining where to direct eye contact of an avatar of a user when a viewing region of that user includes more than one virtual thing. When one of the virtual things (e.g., the volumetric position 620b) is closer to the center of the viewing region than the other virtual thing (e.g., the volumetric position 620c), the eye contact of an avatar of the first user, as seen by another user, is directed towards the virtual thing that is closer to the center of the viewing region.

FIG. 6C is a graphical representation of a directional viewing region for use in determining when to provide eye contact from an avatar to a user viewing a virtual environment. The view of FIG. 6C is a side perspective view of the view shown in in FIG. 6A and FIG. 6B. As illustrated in FIG. 6C, a size of the viewing region may include a directional viewing region 624 (e.g., a vector) that extends outward along the orientation 621 of the first user. As shown, a volumetric position 620b corresponding to a second user is intersected by the directional viewing region 624. When an intersection occurs, eye contact of the first user's avatar is displayed toward the user who corresponds to the volumetric position that is intersected—e.g., the second user who corresponds to the volumetric position 620b. In one embodiment, the volumetric position 620b may be the actual volume occupied by the second user (e.g., occupied by an avatar of the second user). In another embodiment, the volumetric position 620b is a volume around the tracked position of the second user (e.g., that may exceed the volume occupied by an avatar of the second user). In yet another embodiment, the size of the volumetric position 620b occupies a space around a location of the head of the second user's avatar, and may be larger than the size of the head.

FIG. 6D is a graphical representation of a volumetric viewing region for use in determining when to provide eye contact from an avatar to a user viewing a virtual environment. The view of FIG. 6D is a side perspective view of the view shown in in FIG. 6A and FIG. 6B, similar to FIG. 6C. By way of example, FIG. 6D illustrates a viewing region 625 that is a volumetric cone. Of course other volumes may be used, including rectangular prisms or other shapes.

FIG. 6E and FIG. 6F are graphical representations of a method for resizing a viewing region for use in determining when to provide eye contact from an avatar to a user viewing a virtual environment. As illustrated by FIGS. 6E and 6F, a volumetric viewing region can be iteratively resized until only one position of a user is intersected by the volume.

An alternative to the viewing region for determining where to direct eye contact of an avatar of the first user includes directing the eyes of the avatar towards a position of another user that the first user identified by selection, spoken name, or other content association with that other user.

Determining when to Provide Eye Contact from an Avatar to a User Viewing a Virtual Environment

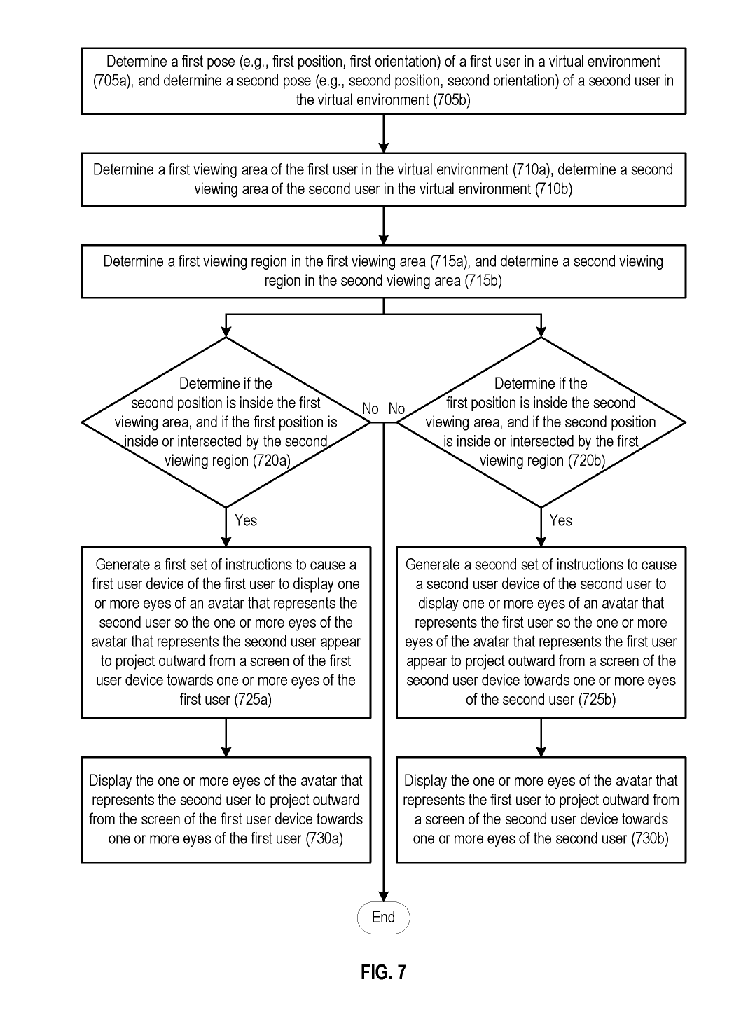

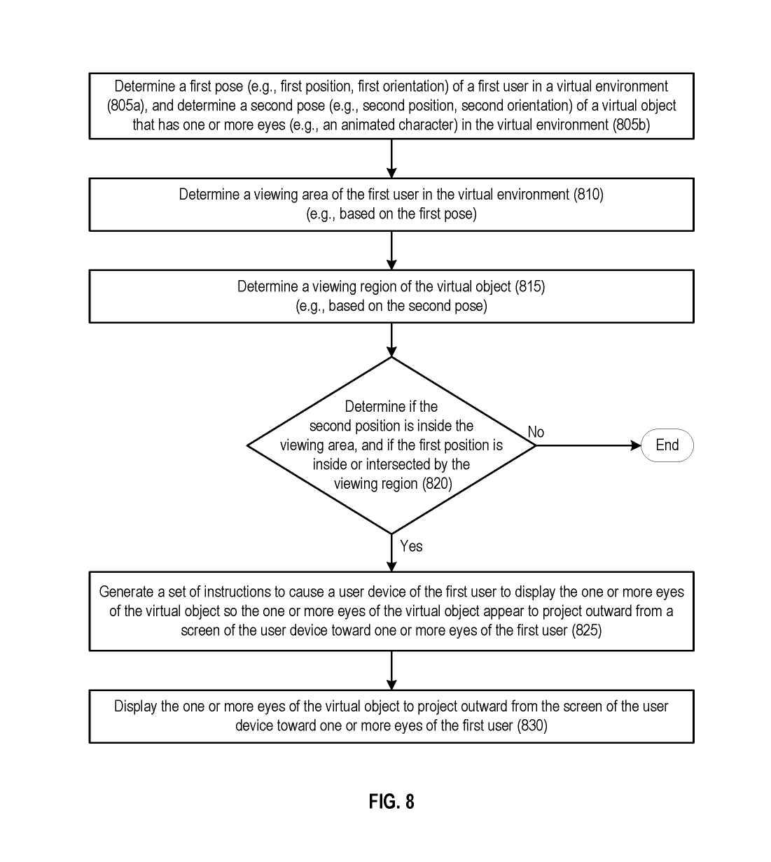

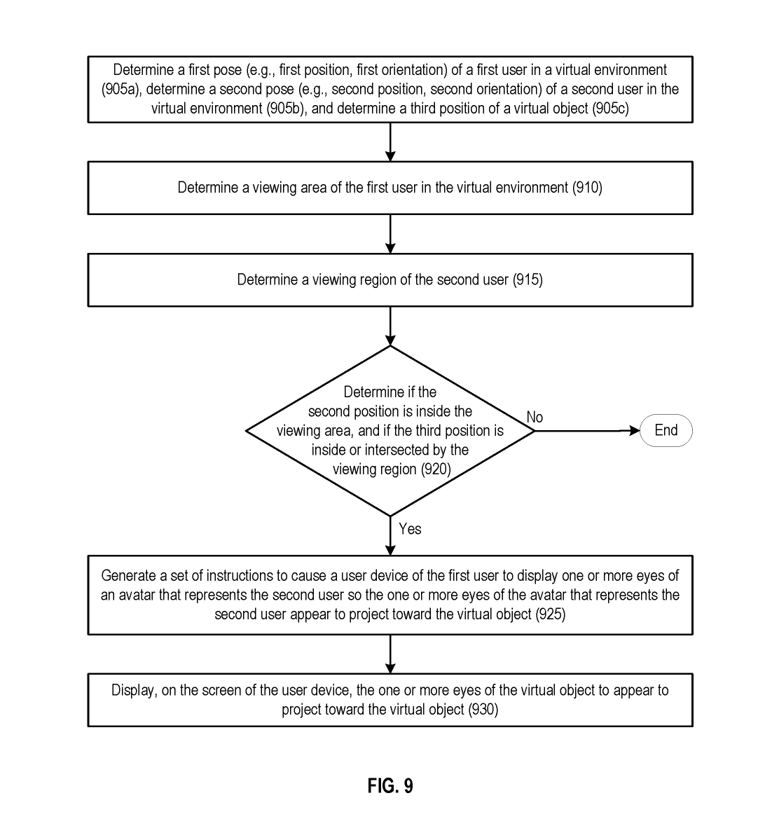

FIG. 7 is a flowchart of a method for tracking and showing eye contact by an avatar to a user operating a user device. The methods shown and described in connection with FIG. 7, FIG. 8, and FIG. 9 can be performed by, for example, by one or more processors of the mixed reality platform 110 (FIG. 1A) and/or the processors 126 (FIG. 1B) associated with devices of one or more users. The steps or blocks of the method shown in FIG. 7 and the other methods disclose herein can also be collaboratively performed by one or more processors of the mixed reality platform 110 and the processors 126 via a network connection or other distributed processing such as cloud computing.

As shown, a first pose (e.g., first position, first orientation) of a first user in a virtual environment is determined (705a), and a second pose (e.g., second position, second orientation) of a second user in the virtual environment is determined (705b). A first viewing area of the first user in the virtual environment is determined (710a), and a second viewing area of the second user in the virtual environment is determined (710b). A first viewing region in the first viewing area is determined (715a), and a second viewing region in the second viewing area is determined (715b).

A determination is made as to whether the second position is inside the first viewing area, and whether the first position (or volume around the first position) is inside or intersected by the second viewing region (720a). If not, the process ends. If the second position is inside the first viewing area, and the first position (or volume around the first position) is inside or intersected by the second viewing region, a first set of instructions to cause a first user device of the first user to display one or more eyes of an avatar that represents the second user so the one or more eyes of the avatar that represents the second user appear to project outward from a screen or display of the first user device towards one or more eyes of the first user are generated (725a), and the one or more eyes of the avatar that represents the second user are rendered and displayed to project outward from the screen of the first user device towards one or more eyes of the first user (730a).

A determination is made as to whether the first position is inside the second viewing area, and whether the second position is inside or intersected by the first viewing region (720b). If not, the process ends. If the first position is inside the second viewing area, and the second position is inside or intersected by the first viewing region, a second set of instructions to cause a second user device of the second user to display one or more eyes of an avatar that represents the first user so the one or more eyes of the avatar that represents the first user appear to project outward from a screen or display of the second user device towards one or more eyes of the second user are generated (725b), and the one or more eyes of the avatar that represents the first user are rendered and displayed to project outward from a screen of the second user device towards one or more eyes of the second user (730b).

FIG. 8 is a flowchart of a process for showing eye contact by an animated character to a user operating a user device. As shown, a first pose (e.g., first position, first orientation) of a first user in a virtual environment is determined (805a), and a second pose (e.g., second position, second orientation) relative to a feature (e.g., eyes) of a virtual object (e.g., an animated character) in the virtual environment is determined (805b). A viewing area of the first user in the virtual environment is determined (810). A viewing region of the virtual object is determined (815). A determination is made as to whether the second position is inside the viewing area, and whether the first position is inside or intersected by the viewing region (820). If not, the process ends. If the second position is inside the viewing area, and if the first position is inside or intersected by the viewing region, a set of instructions to cause a user device of the first user to display the feature (e.g., eyes) of the virtual object so the feature (e.g., eyes) of the virtual object appears to project outward from a screen or display of the user device toward one or more eyes of the first user are generated (825), and the feature (e.g., eyes) of the virtual object are rendered and displayed to project outward from the screen of the user device toward one or more eyes of the first user (830). Other features of the virtual object can be used instead of eyes. For example, a head of the respective avatar can be turned in connection with the eyes, or a limb or other feature can be used or moved.

FIG. 9 is a flowchart of a process for tracking and showing eye contact by an avatar of a user towards a virtual object. As shown, a first pose (e.g., first position, first orientation) of a first user in a virtual environment is determined (905a), a second pose (e.g., second position, second orientation) of a second user in the virtual environment is determined (905b), and a third position of a virtual object is determined (905c). A viewing area of the first user in the virtual environment is determined (910). A viewing region of the second user is determined (915). A determination is made as to whether the second position is inside the viewing area, and whether the third position is inside or intersected by the viewing region (920). If not, the process ends. If the second position is inside the viewing area, and the third position is inside or intersected by the viewing region, a set of instructions to cause a user device of the first user to display one or more eyes of an avatar that represents the second user so the one or more eyes of the avatar that represents the second user appear to project toward the virtual object are generated (925), and the one or more eyes of the virtual object are displayed to appear to project toward the virtual object when displayed on the user device (930).

Intersection can be determined using different approaches. One approach for determining that two things intersect uses a geo-spatial understanding of the volume spaces in the virtual environment that are occupied by different things (e.g., users, virtual objects, and the viewing region). If any part of the volume space of a first thing (e.g., the viewing region) occupies the same space in the virtual environment as any part of the volume space of a second thing (e.g., a user position), then that second thing is intersected by the first thing (e.g., the user position is intersected by the viewing region). Similarly, if any part of the volume space of the viewing region occupies the same space in the virtual environment the entire volume space of a user position, then the user position is “inside” the viewing region. Other approaches for determining that two things intersect can be used, including trigonometric calculations extending a viewing region from a first position occupied by a first user to a second position that is occupied by a second user.

### Other Aspects

Methods of this disclosure may be implemented by hardware, firmware or software (e.g., by the platform 110 and/or the processors 126). One or more non-transitory machine-readable media embodying program instructions that, when executed by one or more computers or machines, cause the one or more computers or machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for determining avatar eye contact in a virtual reality environment, the method comprising:
determining, by at least one processor, a first pose of a first avatar for a first user in a virtual environment,
determining a first viewing area of the first user in the virtual environment based on the first pose;
determining a first viewing region within the first viewing area,
determining a second pose of a second avatar for a second user in the virtual environment;
determining a second viewing area of the second user in the virtual environment based on the second pose;
determining a second viewing region within the second viewing area; and
displaying the second avatar on a first device of the first user and displaying the first avatar on a second device of the second user based on the first viewing region and the second viewing region.

2. The method of claim 1 further comprising:
if a second position of the second avatar is inside the first viewing area, and if a first position of the first avatar is inside or intersected by the second viewing region,
causing the first user device to display one or more eyes of the second avatar of the second user so the one or more eyes of the second avatar appear to project outward from a display of the first user device towards one or more eyes of the first user.

3. The method of claim 1 further comprising:
if a first position of the first avatar is inside the second viewing area, and if a second position of the second avatar is inside or intersected by the first viewing region
causing the second user device to display one or more eyes of the first avatar of the first user so the one or more eyes of the first avatar appear to project outward from a display of the second user device towards one or more eyes of the second user.

4. The method of claim 1 further comprising:
determining that at least a portion of a virtual object is disposed within the first viewing region in addition to the second avatar; and
determining that the virtual object is closer to a center of the viewing region than the second avatar; and
causing the second user device to display the first avatar viewing the virtual object.

5. The method of claim 1 wherein the first pose comprises a first position and a first orientation of the first avatar, and the second pose comprises a second position and a second orientation of the second avatar.

6. The method of claim 1 wherein the first viewing region comprises a volumetric viewing region extending away from the first user position based on an orientation of the first user.

7. The method of claim 6 wherein the volumetric viewing region extends toward a tracked position of an avatar of another user.

8. The method of claim 1 wherein the first viewing region comprises a vector viewing region extending away from the first user position based on an orientation of the first user.

9. A non-transitory computer-readable medium comprising instructions for displaying an augmented reality environment that when executed by one or more processors cause the one or more processors to:
determine a first pose of a first avatar for a first user in a virtual environment,
determine a first viewing area of the first user in the virtual environment based on the first pose;
determine a first viewing region within the first viewing area,
determining a second pose of a second avatar for a second user in the virtual environment;
determine a second viewing area of the second user in the virtual environment based on the second pose;
determine a second viewing region within the second viewing area; and
display the second avatar on a first device of the first user and displaying the first avatar on a second device of the second user based on the first viewing region and the second viewing region.

10. The non-transitory computer-readable medium of claim 9 further causing the one or more processors to:
if a second position of the second avatar is inside the first viewing area, and if a first position of the first avatar is inside or intersected by the second viewing region,
cause the first user device to display one or more eyes of the second avatar of the second user so the one or more eyes of the second avatar appear to project outward from a display of the first user device towards one or more eyes of the first user.

11. The non-transitory computer-readable medium of claim 9 further causing the one or more processors to:
if a first position of the first avatar is inside the second viewing area, and if a second position of the second avatar is inside or intersected by the first viewing region
cause the second user device to display one or more eyes of the first avatar of the first user so the one or more eyes of the first avatar appear to project outward from a display of the second user device towards one or more eyes of the second user.

12. The non-transitory computer-readable medium of claim 9 further causing the one or more processors to:
determine that at least a portion of a virtual object is disposed within the first viewing region in addition to the second avatar; and
determine that the virtual object is closer to a center of the viewing region than the second avatar; and
cause the second user device to display the first avatar viewing the virtual object.

13. The non-transitory computer-readable medium of claim 9, wherein the first pose comprises a first position and a first orientation of the first avatar, and the second pose comprises a second position and a second orientation of the second avatar.

14. The non-transitory computer-readable medium of claim 9, wherein the first viewing region comprises a volumetric viewing region extending away from the first user position based on an orientation of the first user.

15. The non-transitory computer-readable medium of claim 14, wherein the volumetric viewing region extends toward a tracked position of an avatar of another user.

16. The non-transitory computer-readable medium of claim 9, wherein the first viewing region comprises a vector viewing region extending away from the first user position based on an orientation of the first user.
